(19) United States
(12) Patent Application Publication
(10) Pub. No.: US 2026/0166699 A1
(43) Pub. Date: Jun. 18, 2026

(54) NAIL-STRIKING DEVICE AND ELECTRIC NAIL GUN HAVING THE SAME

(71) Applicant: BASSO INDUSTRY CORP., Taichung (TW)

(72) Inventors: Liang-Chi HUNG, Taichung (TW); Sheng-Man WANG, Taichung (TW)

(73) Assignee: BASSO INDUSTRY CORP., Taichung (TW)

(21) Appl. No.: 19/407,738

(22) Filed: Dec. 3, 2025

(30) Foreign Application Priority Data
Dec. 12, 2024 (TW) 113213695

(51) Int. Cl. B25C 1/06; B25C 1/00

(52) U.S. Cl. CPC B25C 1/06; B25C 1/005

(57) ABSTRACT

A nail-striking device includes an actuator member and a nail-striking member. The actuator member is adapted to be in contact with an actuation device to receive kinetic energy along a second axis perpendicular to a first axis, thereby being driven by the kinetic energy to move along the first axis relative to a barrel. The nail-striking member is adapted for striking a nail along the first axis when the nail is conveyed along a first imaginary line into the barrel. The nail-striking member has a cross section that extends in a direction of a third axis and a direction of the second axis and that is elongated along a reference line perpendicular to the first imaginary line. The third axis is perpendicular to the first axis and the second axis. The reference line is inclined at a first angle to the third axis. The first angle ranges between 10-30 degrees.

### CROSS-REFERENCE TO RELATED APPLICATION

This application claims priority to Taiwanese Utility Model patent application No. 113213695, filed on Dec. 12, 2024, the entire disclosure of which is incorporated by reference herein.

### FIELD

The disclosure relates to an electric nail gun, and more particularly to a nail-striking device and an electric nail gun having the same.

### BACKGROUND

A conventional driving tool of a conventional electric nail gun disclosed in U.S. Pat. No. 11,975,433B2 includes a flywheel and a driver. When the driver is at a position tangent to a circumference of the flywheel, the flywheel drives the driver to move along an axis to strike a nail that is disposed inside a barrel of the electric nail gun.

Generally, the nail is moved into the barrel from a magazine in a direction perpendicular to the axis, so that the driver is able to strike the nail.

A configuration of the flywheel and the driver is restricted so that kinetic energy is transmitted from the flywheel to the driver in a direction perpendicular to the axis. If the nail is not moved in the direction perpendicular to the axis when entering the barrel, the nail deviates from a striking area of the driver, which may cause the driver to be unable to strike a nail head of the nail to fire the nail.

### SUMMARY

Therefore, an object of the disclosure is to provide a nail-striking device, an electric nail gun and nail-striking unit that can alleviate at least one of the drawbacks of the prior art.

According to one aspect of the disclosure, the nail-striking device is adapted to be mounted to an electric nail gun. The electric nail gun includes a gun body, a barrel connected to the gun body and extending along a first axis, a magazine device connected to the barrel and operable for conveying a nail into the barrel along a first imaginary line that intersects the first axis, and an actuation device mounted to the gun body and for converting electrical energy to kinetic energy. The nail-striking device includes an actuator member and a nail-striking member. The actuator member is adapted to be mounted to the actuation device, and is adapted to be in contact with the actuation device to receive the kinetic energy from the actuation device along a second axis perpendicular to the first axis, so that the actuator member is driven by the kinetic energy to move along the first axis relative to the barrel. The nail-striking member is connected to the actuator member, and is adapted for striking the nail along the first axis when the nail is conveyed into the barrel. The nail-striking member has a cross section that extends in a direction of a third axis and a direction of the second axis and that is elongated along a reference line perpendicular to the first imaginary line. The third axis is perpendicular to the first axis and the second axis. The reference line is inclined at a first angle to the third axis. The first angle ranges between 10-30 degrees.

Another aspect of the disclosure is to provide an electric nail gun that includes a gun body, a barrel, a magazine device, an actuation device, and the abovementioned nail-striking device. The barrel is connected to the gun body and extends along a first axis. The magazine device is connected to the barrel, and is operable for conveying a nail into the barrel along a first imaginary line intersecting the first axis. The actuation device is mounted to the gun body and is for converting electrical energy to kinetic energy. The nail-striking device is mounted between the gun body and the barrel.

Yet another aspect of the disclosure is to provide a nail-striking unit that includes a connector member that has a cross section elongated along an axis, and a nail-striking member that extends coaxially from the connector member and that has a cross section elongated along a reference line. The reference line is inclined at a first angle to the axis. The first angle θ₁ ranges between 10-30 degrees.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an embodiment of an electric nail gun according to the disclosure.

FIG. 2 is a front view of the embodiment.

FIG. 3 is a fragmentary sectional view of the embodiment.

FIG. 4 a fragmentary sectional view of the embodiment taken along line IV-IV in FIG. 3.

FIG. 5 is an exploded perspective view of a nail-striking device of the embodiment.

FIG. 6 is a side view of the nail-striking device.

FIG. 7 is a sectional view of the nail-striking device.

FIG. 8 is a fragmentary sectional view, illustrating a nail being fired by the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

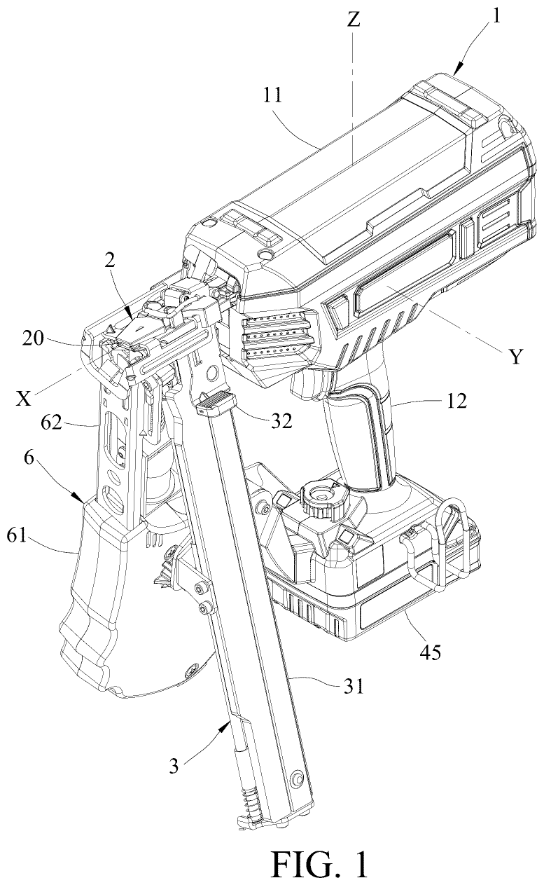

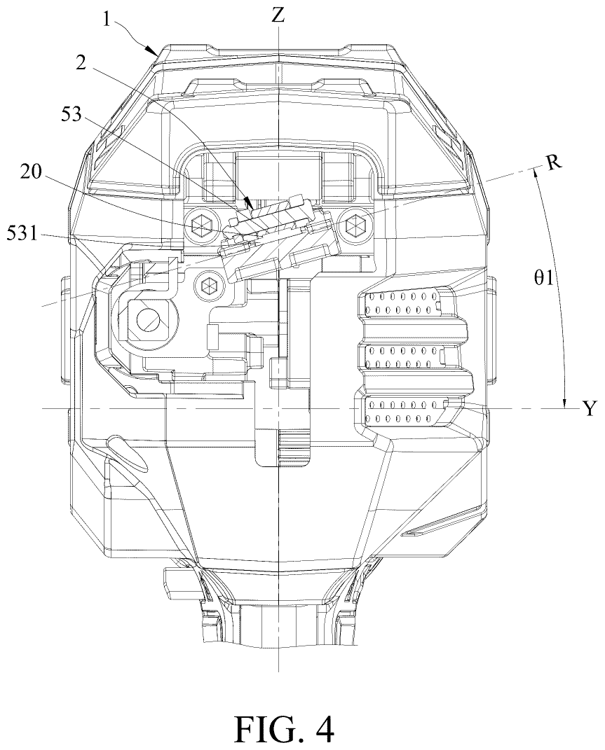

Referring to FIGS. 1 to 4, an embodiment of an electric nail gun according to the disclosure includes a gun body 1, a barrel 2, a magazine device 3, an actuation device 4, a nail-striking device 5, and a plate magazine device 6.

The gun body 1 has a main body portion 11, and a grip portion 12 that is connected to the main body portion 11 and that is for a user to grip.

Referring to FIG. 1, it should be noted that, in the following description, a first axis (X) extends in a front-rear direction through the main body portion 11, a second axis (Z) extends in an up-down direction and is perpendicular to the first axis (X), and a third axis (Y) extends in a left-right direction, and is perpendicular to the first axis (X) and the second axis (Z).

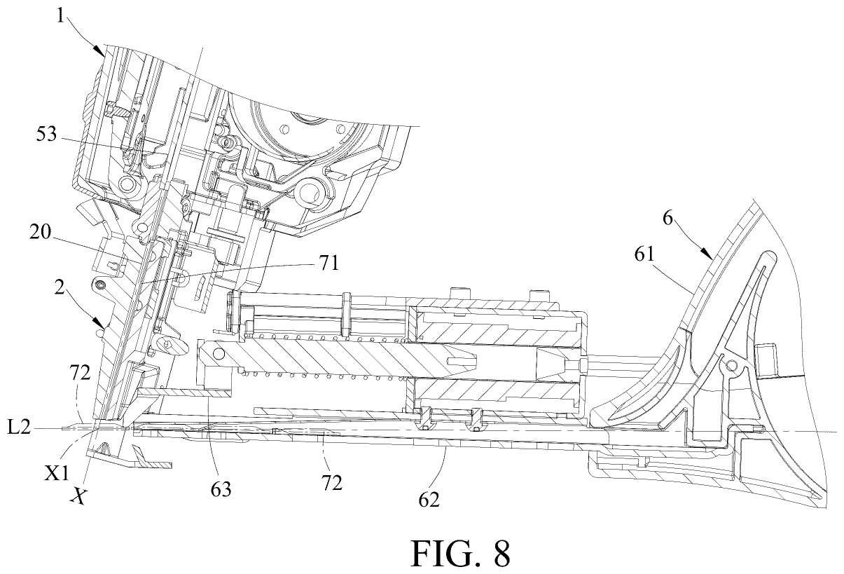

The barrel 2 is connected to the main body portion 11 and extends along the first axis (X). The barrel 2 defines a nail channel 20 that extends along the first axis (X), and that is adapted for accommodating a plurality of nails 71 (shown in FIG. 8) therein.

The magazine device 3 includes a nail cartridge 31 that is connected to the gun body 1 and the barrel 2, and that is adapted for accommodating the nails 71, and a nail feeder member 32 that is movably mounted in the nail cartridge 31. The nail cartridge 31 extends along a first imaginary line (L1) intersecting the first axis (X). The nail feeder member 32 is movable along the first imaginary line (L1) for conveying the nails 71 one by one into the barrel 2 along the first imaginary line (L1). For the sake of brevity, only one of the nails 71 will be mentioned in the following description.

The actuation device 4 includes a flywheel 41 that is rotatably mounted to the gun body 1, a motor 42 that is mounted to the gun body 1 and that is operable for driving the flywheel 41 to rotate, an arm unit 43 that is pivotably mounted to the gun body 1, a solenoid valve 44 that is mounted to the gun body 1, and a battery unit 45 for providing electrical energy to the motor 42 and the solenoid valve 44. The motor 42 is for converting electrical energy to kinetic energy, and the kinetic energy is transmitted to other components of the embodiment through the flywheel 41.

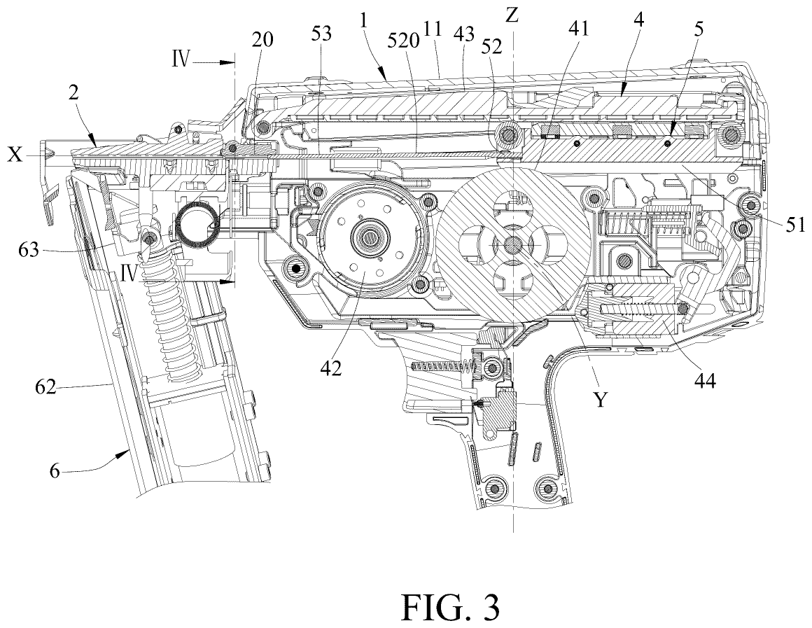

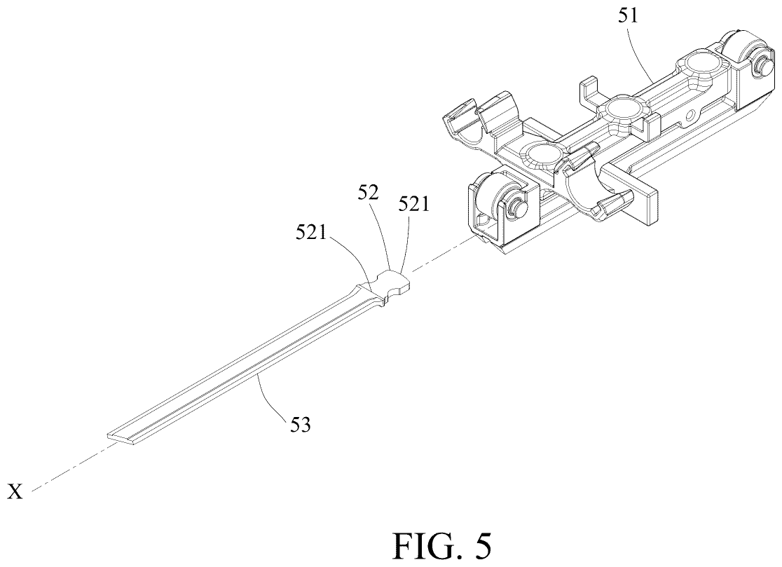

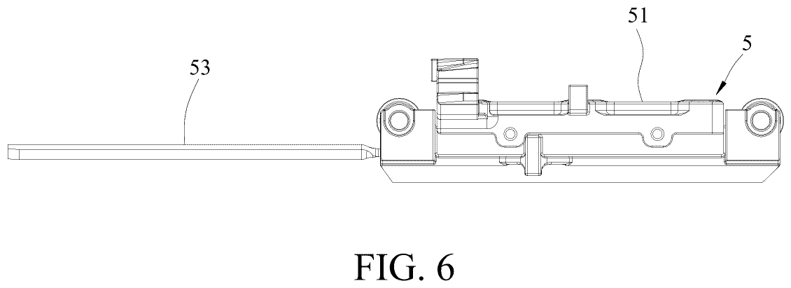

Referring to FIGS. 3 and 5 to 7, the nail-striking device 5 is mounted between the gun body 1 and the barrel 2, and includes an actuator member 51 that is mounted to the arm unit 43, and a nail-striking unit 520. The nail-striking unit 520 includes a connector member 52 that is connected to the actuator member 51, and a nail-striking member 53 that extends coaxially from the connector member 52 along the first axis (X) into the nail channel 20, and that is adapted for striking the nail 71 along the first axis (X) when the nail 71 is conveyed into the barrel 2.

The solenoid valve 44 is operable for driving the arm unit 43 and the actuator member 51 to pivot downwardly along the second axis (Z) and to abut the actuator member 51 against the flywheel 41, such that the actuator member 51 is in contact with the actuation device 4 to receive the kinetic energy from the actuation device 4 along the second axis (Z), and the actuator member 51 is driven by the flywheel 41 to move along the first axis (X) for striking the nail 71 when the nail 71 is conveyed into the barrel 2.

The connector member 52 is elongated along the first axis (X), is parallel to the third axis (Y), and has two end surfaces 521 that are opposite to each other along the first axis (X). One of the end surfaces 521 is connected to the nail-striking member 53 and faces the barrel 2, and another one of the end surfaces 521 is movably disposed in the actuator member 51. In this embodiment, the connector member 52 is slotted in the actuator member 51. In this embodiment, the connector member 52 and the nail-striking member 53 are integrally formed.

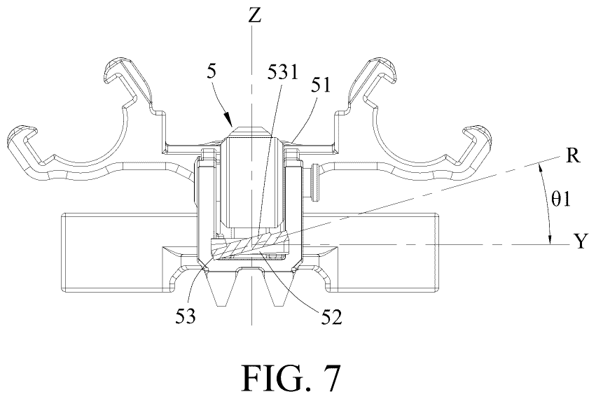

Referring to FIG. 7, the connector member 52 has a cross section that is elongated along the axis (Y), and the nail-striking member 53 has a cross section 531 that is elongated along a reference line (R) perpendicular to the first imaginary line (L1). Specifically, the cross section of the connector member 52 extends in a direction of the third axis (Y) and a direction of the second axis (Z) and is elongated along the axis (Y), and the cross section 531 of the nail-striking member 53 extends in the direction of the third axis (Y) and the direction of the second axis (Z) and is elongated along the reference line (R). The reference line (R) is inclined at a first angle (θ₁) to the third axis (Y). The first angle (θ₁) ranges between 10-30 degrees. In some embodiments, the first angle (θ₁) may range between 15-25 degrees. In this embodiment, the first angle (θ₁) is 20 degrees, and the nail-striking member 53 is flat. A shape of the nail channel 20 corresponds to a shape of the cross section 531 of the nail-striking member 53 and is elongated along the reference line (R).

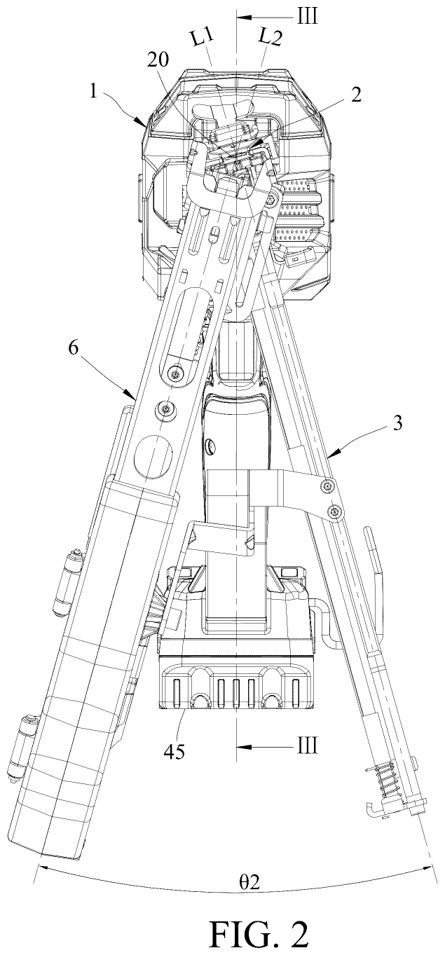

Referring to FIGS. 1 to 3 and 8, the plate magazine device 6 is connected to the gun body 1 and the barrel 2, and extends along a second imaginary line (L2). The second imaginary line (L2) intersects the first axis (X) at an intersection point (X1) that is spaced apart from the barrel 2. The second imaginary axis (L2) is inclined at a second angle (θ₂) to the first imaginary line (L1). The second angle (θ₂) ranges between 20-40 degrees. In some embodiments, the second angle (θ₂) may range between 30-32 degrees. In this embodiment, referring to FIG. 2, the plate magazine device 6 and the magazine device 3 form an A-shape, such that weight of the embodiment is evenly distributed. It should be noted that, if the second angle (θ₂) is smaller than 20 degrees, the plate magazine device 6 may collide with other components of the embodiment. If the second angle (θ₂) is greater than 40 degrees, the embodiment takes up a lot of space.

The plate magazine device 6 includes a plate cartridge 61 adapted for accommodating a plurality of plates 72, a plate rail 62 connected to the plate cartridge 61 and adapted for guiding movement of the plates 72, and a plate feeder 63 mounted to the plate rail 62 and operable for pushing the plates 72 to move along the second imaginary line (L2) towards the intersection point (X1).

It should be noted that, the main feature of the disclosure is the nail-striking device 5. Since the nail magazine unit 3, the actuation device 4, and the plate magazine device 6 are well known in the art, further description thereof will be omitted for the sake of brevity.

Referring to FIG. 3, when the electric nail gun is in a normal state, the arm unit 43 and the actuator member 51 are away from the flywheel 41. At this time, the nail 71 is inside the nail channel 20, and one of the plates 72 is disposed at the intersection point (X1).

Referring to FIG. 8, after the arm unit 43 and the actuator member 51 are driven by the solenoid valve 44 to pivot downwardly along the second axis (Z), and after the actuator member 51 abuts against the flywheel 41, the actuator member 51 receives the kinetic energy from the actuation device 4 along the second axis (Z), so that the actuator member 51 is driven by the kinetic energy to move along the first axis (X) relative to the barrel 2 and the arm unit 43 for striking the nail 71.

After the nail 71 is struck, the nail 71 moves along the first axis (X) through the barrel 2 and pierces the plate 72 at the intersection point (X1), such that after the nail 71 is fired by the electric nail gun, the nail 71 and the plate 72 are driven to an object (not shown) together.

It should be noted that, in other embodiments, the plate magazine device 6 may be omitted, and the electric nail gun only fires a nail through the nail-striking member 53.

Referring to FIGS. 3, 4 and 7, the advantages of the electric nail gun of the disclosure are as follows.

1. Since the cross section 531 of the nail-striking member 53 is elongated along the reference line (R), the nail-striking member 53 is able to strike the nail 71 when the nail 71 is conveyed into the barrel 2, so that neither a movement direction of the actuation member 51 nor a transfer route of the kinetic energy between the actuation member 51 and the flywheel 41 are affected.

2. By virtue of the configuration of the nail-striking device 5, the nail-striking member 53 is able to strike the nail 71 that is conveyed into the barrel 2 along the first imaginary line (L1) without the necessity of changing the configuration of the actuation device 4. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A nail-striking device that is adapted to be mounted to an electric nail gun, the electric nail gun including a gun body, a barrel connected to the gun body and extending along a first axis, a magazine device connected to the barrel and operable for conveying a nail into the barrel along a first imaginary line that intersects the first axis, and an actuation device mounted to the gun body and for converting electrical energy to kinetic energy, said nail-striking device comprising:
an actuator member that is adapted to be mounted to the actuation device, and that is adapted to be in contact with the actuation device to receive the kinetic energy from the actuation device along a second axis perpendicular to the first axis so that said actuator member is driven by the kinetic energy to move along the first axis relative to the barrel; and
a nail-striking member that is connected to said actuator member, and that is adapted for striking the nail along the first axis when the nail is conveyed into the barrel, said nail-striking member having a cross section that extends in a direction of a third axis and a direction of the second axis and that is elongated along a reference line perpendicular to the first imaginary line, the third axis being perpendicular to the first axis and the second axis, the reference line being inclined at a first angle to the third axis, said first angle ranging between 10-30 degrees.

2. The nail-striking device as claimed in claim 1, further comprising a connector member that is connected to said actuator member, said nail-striking member extending along the first axis from said connector member, said connector member having two end surfaces that are opposite to each other along the first axis, one of said end surfaces being connected to said nail-striking member and facing said barrel, another one of said end surfaces being movably disposed in said actuator member.

3. The nail-striking device as claimed in claim 1, wherein said first angle ranges between 15-25 degrees.

4. An electric nail gun comprising:
a gun body;
a barrel that is connected to said gun body and that extends along a first axis;
a magazine device that is connected to said barrel, and that is operable for conveying a nail into said barrel along a first imaginary line intersecting the first axis;
an actuation device that is mounted to said gun body and that is for converting electrical energy to kinetic energy; and
said nail-striking device as claimed in claim 1, said nail-striking device being mounted between said gun body and said barrel.

5. The electric nail gun as claimed in claim 4, further comprising a plate magazine device that is connected to said gun body and said barrel, and that extends along a second imaginary line, the second imaginary line intersecting the first axis at an intersection point that is spaced apart from said barrel, said plate magazine device being operable for pushing a plate to move along the second imaginary line towards the intersection point.

6. The electric nail gun as claimed in claim 4, wherein the second imaginary axis is inclined at a second angle to the first imaginary axis, said second angle ranging between 20-40 degrees.

7. The electric nail gun as claimed in claim 4, wherein:
said actuation device includes a flywheel that is rotatably mounted to said gun body, a motor that is mounted to said gun body and that is operable for driving said flywheel to rotate, an arm unit that is pivotably mounted to said gun body, and a solenoid valve that is mounted to said gun body; and
said solenoid valve is operable for driving said arm unit and said actuator member to pivot downwardly along the second axis and to abut said actuator member against said flywheel, such that said actuator member is driven by said flywheel to move along the first axis for striking the nail when the nail is conveyed into the barrel.

8. The electric nail gun as claimed in claim 7, wherein said actuation device further includes a battery unit for providing electrical energy to said motor and said solenoid valve.

9. The electric nail gun as claimed in claim 4, wherein said barrel defines a nail channel that is adapted for accommodating the nail therein, a shape of said nail channel corresponding to a shape of said cross section of said nail-striking member and being elongated along the reference line.

10. A nail-striking unit comprising:
a connector member that has a cross section elongated along an axis; and
a nail-striking member that extends coaxially from said connector member and that has a cross section elongated along a reference line, the reference line being inclined at a first angle to the axis, said first angle ranging between 10-30 degrees.
